(19) United States
(12) Patent Application Publication
(10) Pub. No.: US 2015/0225644 A1
(43) Pub. Date: Aug. 13, 2015

(54) LUMINESCENT MATERIAL FOR SOLID-STATE SOURCES OF WHITE LIGHT

(71) Applicants: Anatoly Vasilyevich Vishnyakov, Moscow (RU); Yaohui Chang, Shahekou (CN); Ekaterina Anatolyevna Vishniakova, Moscow (RU)

(72) Inventors: Anatoly Vasilyevich Vishnyakov, Moscow (RU); Yaohui Chang, Shahekou (CN); Ekaterina Anatolyevna Vishniakova, Moscow (RU)

(21) Appl. No.: 14/425,551

(22) PCT Filed: Dec. 6, 2012
(86) PCT No.: PCT/RU2012/001026

§ 371 Date: Mar. 3, 2015

(51) Int. Cl. C09K 11/77; F21V 9/16

(52) U.S. Cl. CPC C09K 11/7774; F21V 9/16

(57) ABSTRACT

The invention relates to the field of lighting technology on the basis of blue-radiating light-emitting diodes and, in particular, to luminescent materials comprising yttrium oxide, ceric oxide and aluminium oxide, which are taken in a ratio ensuring the production of a light-radiating composition, the content of which corresponds to general formula (Y₁₋ₓCeₓ)_{3±α}Al₅O_{12±1,5α,}; x is the atomic fraction of cerium equal to 0.01-0.20; where α is the magnitude characterizing an increase or decrease in the stoichiometric index in comparison to the known index (3) for yttrium garnet and changing within a range from zero to 0.5 for positive values and from 0 to 1.5 for negative values, excluding α=0 from the set of possible values. At 0.03<x<0.15, the colour temperature of the solid-state source of white light changes from 3500 to 4500 K with variation of the values (3±α) from 1.5 to 3.5. Samples which can thereby be produced are comparable in terms of colour coordinates and brightness to the best commercial samples.

This invention relates to lighting engineering, in particular to luminescent materials, emitting under blue light excitation in the yellow-orange part of the spectrum and used in solid sources of white light. White light is produced in these devices due to a combination of yellow-orange luminescence of the phosphor with primary blue emission generated by a light diode emitting in the blue part of the spectrum (440-480 nm).

Effectiveness of such devices depends on the chemical composition of luminescent materials, which could be silicates, phosphates, oxides, aluminates, nitrides and oxy-nitrides [C. Ronda, Luminescence: From Theory to Application. Science, 2007, 260 pp]. Aluminate phosphors with a garnet structure activated by cerium (denoted as YAG:Ce in literature) are the most effective variety among the above materials. They belong to the class of yttrium, gadolinium or other rare-earth elements aluminates.

A broad-band phosphor with yellow-orange luminescence, based on yttrium-aluminum garnet, activated with (Y-Ce)₃Al₅O₁₂ was fist patented by G. Blasse and A. Brile of “Phillips” in several countries, including the USA: U.S. Pat. No. 3,564,322 (U.S. Class: 313/468; Intern'l Class: C09K11/77) of Feb. 16, 1971; primary priority granted on Apr. 29, 1967. Synthesis of this phosphor is carried out by sintering a mixture of yttrium, aluminum and cerium oxides in a reducing atmosphere, which produces a compound with some Y³⁺ions replaced with Ce³⁺ions. Consequently, Blasse-Brile's garnet is a compound with a fixed stoichiometric composition, in which yttrium is partly replaced with cerium in the 0.01-0.20 concentration range: (Y₁₋ₓCeₓ³⁺)₃Al₅O₁₂.

In recent years, inventers concentrated their attention only on creating more compounds of greater complexity, of various compositions, which included two or more yttrium-replacing lanthanides. The first compound of this kind, (Y, Gd, Ce)₃Al₅O₁₂ was described in the 1970s. References to that compound can be found in fundamental handbooks on luminescent materials (G. Blasse and B. C. Grabmaier, “Luminescent Materials:, Springer-Verlag, Berlin (1994); S. Shionoya, Phosphor Handbook/Science (1998), 921 pp.)

Thirty years after G. Blasse, in 1998-2008, the Japanese Company “Nichia” was awarded several patents for a device consisting of a semiconductor InGaN heterojunction, which generates light with 450-470 nm wavelength, covered with grains of fluorescent material of a yttrium-aluminum garnet structure, activated with cerium (U.S. Pat. No. 5,998,925 (U.S. Class: 313/503; Intern'l Class: H01J001/62) of Dec. 7, 1997, U.S. Pat. No. 6,069,440 (U.S. Class: 313/486,489; Intern'l Class: H01L 033/00) of May 30, 2000, U.S. Pat. No. 6,608,332 (U.S. Class: 257/98) of Aug. 19, 2003, U.S. Pat. No. 6,614,179 (U.S. Class: 353/512; Intern'l Class: H01L 33/00) of Aug. 19, 2003, U.S. Pat. No. 7,362,048 (U.S. Class: 313/512).

The authors of all of the above patents use a compound, the composition of which corresponds to the following formula: (Y₁₋ₓLnₓ)₃(Al_{1-a-b-c}Gaₐn_{b})₅O₁₂, where yttrium, gadolinium and cerium are among the main rare-earth metals, while Lu, Sm, La and Sc are also included.

Later on, were patented compounds, containing from 5 to 14 lanthanides: US 20080116422 (U.S. Class: 252/301.4R; Intern'l Class: C09K11/08) of May 22, 2008 and US 20080290355 (U.S. Class: 257/94; Intern'l Class: C09K11/08) of Nov. 27, 2008. The first of these patents offers a compound corresponding to the following formula: (Y_{l-x-y-z-p-q}GdₓTb_{y}Yb_{z}LuₚCe_{q})₃Al₅0₁₂. It contains Tb and Yb in addition to Gd, Ce, Lu and Sm. The phosphore offered in Patent US No. 20080290355 by the same authors corresponds to the formula:

(Y_{l-x-y-z-p-q}GdₓLu_{y}Yb_{z}Euₚ+activating additions of Ce, Pr, Dy, Er, Sm)₃Al₅O₁₂, has the lanthanide group that includes 9 out of 14 f-elements.

The chemical composition of these phosphors corresponds to the stoichiometric formula: (Y+Ln)₃(Me³⁺)₅O₁₂, where Ln is Gd, Ce and one or more elements selected from the lanthanide group; Me³⁺is either aluminum on its own or with one or more elements from the Ga, In, Sc group. The (Y+Ln)/Me³⁺ratio is firmly fixed at 3/5.

It is worth a note that the key role in luminescent properties yttrium-aluminum garnets belongs to Ce³⁺, which activates luminescence, i.e. is the element, the optical transitions of which determine the color of glow, while its concentration assigns the brightness of luminescence.

Gd, Tb and Lu belong to the category of additions forming the luminescent matrix. They are responsible for shift of the maximum in the luminescence spectrum to either the long-wave (Gd, Tb) or short wavelength (Lu) part of the spectrum (Ga, In and Sc can play a similar role). Other rare-earth elements: Nd, Eu, Dy, Er, Ho and Tm play an auxiliary part, which was mentioned in several patents, but their quantitatively their contribution was not characterized. The total number of patented compositions of complex cation compositions with a fixed stoichiometry (3-5-12) has reached several tens.

Some patents published during the last 5-7 years offered compounds with stoichiometry which differs from 3:5 ratio: some with an excess of rare-earth elements, others—with an excess of aluminum.

Inventors from “General Electric” were awarded 5 patents for terbium, lutetium and terbium-lutetium garnets from 2001 to 2003: U.S. Pat. No. 6,598,195 (Jul. 22, 2003), U.S. Pat. No. 6,630,077 (Oct. 7, 2003), U.S. Pat. No. 6,793,848 (Sep. 21, 2004), U.S. Pat. No. 6,936,857 (Aug. 30, 2005), and U.S. Pat. No. 7,008,558 (Mar. 7, 2006). The first of which is the most important patent for that group. In that patent all the possible variations of the indices of (Ln)ₐ and (Al,Ga,In)_{z} were denoted as 2.8<a<3 and 4<z<5 respectively. It needs to be emphasized that the authors of that patent, varying the indices of Ln and Al, i.e. describing—in essence—a non-stoichiometric garnet, ascribed an index of 12 to oxygen. Taking into account that the charge state of every metal representing a particular composition of the patented phosphores corresponds to Me³⁺, keeping the index of oxygen at 12 for a single-phase compound is only possible when the charge state of lanthanide group metals is above 3. The latter is impossible in principle because phosphors are produced under reducing conditions (high temperatures and a presence of hydrogen), in which case the stable state of terbium and cerium is 3+.

The compound for which “General Electric” was awarded the latest patent (7,008,558, Mar. 7, 2006) had the following formula: (G_{l-x-y}AₓRe_{y})ₐD_{z}O_{12,} and the variations of the stoichiometric indices “a” and “z” were denoted as 2.8<a<3.1 and 4<z<5.1 (preferably, 2.884<a<3.032 and 4.968<z<5.116).

U.S. Pat. No. 7,135,129 (U.S. Class: 252/301.4R; Intern'l Class: C09K11/08 of Nov. 14, 2006 was issued in 2006 for the following phosphore: (Y_{l-x-y-z-q}GdₓDy_{y}Yb_{z}Er_{q}Ceₚ)α (Alₗ₋ₙ₋ₘ₋ₖGaₙSc_{m In}ₖ)_{β}O₁₂, the stoichiometric indices and of which were: α=2.97-3.02 and β=4.98-5.02. In U.S. Patent Application 20090153027 (U.S. Class: 313/503; Intern'l Class: C09K11/78) of Jun. 19, 2009 the following phosphor was described: [Y_{2-x-y-z-q}GdₓCe_{y}Pr_{z}DyₚO₃]_{1.5±α}+(Al₂O₃)2.5±β), where α=(0.01-0.1) and β=(0.01-0.1). According to the authors, the preferred values were 0.01 for α and 0.03 for β.

The compounds offered in patent Applications WO2011/014091A1 (PCT/RU 2009/000374) and WO2012/053924 (PCT/RU2010/000619) had indices of the yttrium sub-lattice elements varying between 3.03 and 5 (an excess of yttrium) and, correspondingly, between 2.8 and 1.0 (an excess of aluminum). It was shown that the characteristics of phosphors with the index differing from the stoichiometric garnet (3) were as good and in some characteristics: cost, brightness, color coordinates, better than those shown by stoichiometric garnets (“3-5-12”).

However, irrespective of whether the composition of a phosphor was stoichiometric or not, the luminescent materials patented by Blasse-Brile always contained in addition to cerium at least one more lanthanide, which only corrected the activation effect of cerium.

The prototype of the present invention is Blasse-Brile's U.S. Pat. No. 3,564,322, issued for the compounds corresponding to the formula: (Y₁₋ₓCeₓ)₃Al₅O₁₂. Its drawback is that only a limited number of phosphors can be synthesized within that formula, differing from one another only in their cerium concentration.

The present invention aims at broadening the range of inorganic luminescent materials for solid white light sources.

This goal is achieved by producing a new luminescent material for solid white light sources, based on yttrium aluminate, which also includes yttrium cerium and aluminum oxides, and the composition of this inorganic luminescent material is represented by the following general formula:

(Y₁₋ₓCeₓ)_{3±α}Al ₅O_{12±1.5α}

where α characterises the stoichiometric index deviation from 3 for yttrium garnet, and it varies from zero to 0.5 for its positive values and from 0 to 1.5 for its negative values, excluding α=0 from the set of possible values, while x is the atomic fraction of cerium, which equals 0.01-0.20.

Consequently, unlike the prototype, the ratio between the mole quantities in the present invention varies within a broad range of compositions: 0.3<[Yₗ₋ₓCeₓ]/Al≦0.7, while that ratio in the prototype was fixed at 0.6.

### PRACTICAL EXAMPLES

Four series of samples with an assigned (for each particular series) cerium content and a variable [Y₁₋ₓCeₓ]/Al ratio, namely: (Y₁₋ₓCeₓ)_{1.5}Al₅O_{9.75}, (Y₁₋ₓCeₓ)_{2.8}Al₅O_{11.70}, (Y₁₋ₓCeₓ)_{3.20}Al₅O_{12.30}, and (Y₁₋ₓCeₓ)_{3.50}Al₅O_{12.75}. Cerium concentration decreased from one series to the next: x=0.15, 0.10, 0.05 and 0.01. The data for characteristics within each particular series are shown in the table below, where each series is separated with a space.

The total number of samples was 16, different from one another in the (3±α) index as well as in their cerium content. Compositions of the luminescent materials are also presented in Table 1. Sample No. 17, the composition of which is that of the prototype, was also included.

The phosphors were produced by sintering of a mixture of yttrium and cerium oxides and aluminum hydroxide. The phosphor synthesis was carried on in the presence of fluxes, which accelerated mass transfer by forming a liquid phase on the surface of the reacting solid products and, consequently, they accelerated the formation of the target product of these reactions.

Mixtures of barium chloride and fluoride were used as the flux (up to 7-10% of the mass of the oxides).

Dry powders of raw materials (yttrium and cerium-IV oxides, aluminum hydroxide and flux) were mixed in ‘3d’ rotation mixer or by means vibrating technique, keeping the powders in polyethylene vessels and using polyethylene-covered steel balls. Heat treatment was carried out in alumina (Al₂O₃) crucibles in an (N₂+H₂) atmosphere at 1450C. After loading the samples into the furnace the temperature was raised at rate of 7 degrees/min starting from room temperature. Heating at that temperature continued for 3-5 hours, then the crucibles were cooled down to 400 C., which took 2.5 hours.

To remove the fluxes, the prepared samples were washed several times with a large quantity of distilled water and dried out in an oven at 130 C. The prepared luminescent materials had a particle size of 7-15 (measured with the laser particle size analyzer).

Optical characteristics of the phosphors were measured, using a certified EVERFINE-HAAS installation in reflection mode of blue light from prepared phosphor powders having yellow-orange luminescence. The values presented in the table correspond to the parameters characterising luminescent properties of samples in the interval of 470-780 nm wave lengths (without the blue LED emission).

TABLE 1
CHARACTERISTICS OF PREPARED LUMINESCENT MATERIALS

| | | Characteristics of yellow-orange luminescence band | | | | | | |
|---|---|---|---|---|---|---|---|---|
| | | I, | λ_{dom}, | λₚₑₐₖ, | Δλ_{0.5}, | Color coordinates | | |
| No. | Phosphore composition | a.u. | nm | nm | nm | x | y | T_{c}, K |
| 1 | (Y_{0.85}Ce_{0.15})_{1.50}Al₅O_{9.75} | 499 | 568.4 | 543.2 | 113.1 | 0.425 | 0.548 | 4028 |
| 2. | (Y_{0.85}Ce_{0.15})_{2.80}Al₅O_{11.70} | 526 | 568.5 | 546.3 | 112.5 | 0.427 | 0.549 | 4005 |
| 3. | (Y_{0.85}Ce_{0.15})_{3.20}Al₅O_{12.30} | 527 | 568.9 | 546.8 | 112.6 | 0.430 | 0.547 | 3956 |
| 4. | (Y_{0.85}Ce_{0.15})_{3.50}Al₅O_{12.75} | 538 | 568.9 | 547.9 | 113.2 | 0.429 | 0.547 | 3962 |
| 5. | (Y_{0.90}Ce_{0.10})_{1.50}Al₅O_{9.75} | 502 | 570.8 | 556.5 | 115.3 | 0.443 | 0.537 | 3730 |
| 6. | (Y_{0.90}Ce_{0.10})_{2.80}Al₅O_{11.70} | 506 | 571.9 | 557.6 | 115.7 | 0.452 | 0.532 | 3584 |
| 7. | (Y_{0.90}Ce_{0.10})_{3.20}Al₅O_{12.30} | 506 | 572.1 | 559.2 | 115.4 | 0.453 | 0.531 | 3558 |
| 8. | (Y_{0.90}Ce_{0.10})_{3.50}Al₅O_{12.75} | 517 | 571.3 | 557.6 | 115.1 | 0.447 | 0.535 | 3658 |
| 9. | (Y_{0.95}Ce_{0.05})_{1.50}Al₅O_{9.75} | 487 | 572.0 | 558.8 | 117.2 | 0.452 | 0.531 | 3581 |
| 10. | (Y_{0.95}Ce_{0.05})_{2.80}Al₅O_{11.70} | 514 | 572.6 | 558.4 | 116.3 | 0.457 | 0.528 | 3493 |
| 11. | (Y_{0.95}Ce_{0.05})_{3.20}Al₅O_{12.30} | 509 | 572.5 | 558.8 | 116.4 | 0.456 | 0.529 | 3513 |
| 12. | (Y_{0.95}Ce_{0.05})_{3.50}Al₅O_{12.75} | 501 | 572.0 | 556.9 | 116.1 | 0.453 | 0.531 | 3568 |
| 13. | (Y_{0.99}Ce_{0.01})_{1.50}Al₅O_{9.75} | 403 | 565.4 | 534.3 | 111.3 | 0.403 | 0.559 | 4385 |
| 14. | (Y_{0.99}Ce_{0.01})_{2.80}Al₅O_{11.70} | 445 | 565.7 | 535.5 | 110.8 | 0.405 | 0.558 | 4353 |
| 15. | (Y_{0.99}Ce_{0.01})_{3.20}Al₅O_{12.30} | 438 | 565.7 | 532.7 | 110.9 | 0.405 | 0.557 | 4358 |
| 16. | (Y_{0.99}Ce_{0.01})_{3.50}Al₅O_{12.75} | 430 | 566.1 | 535.4 | 111.5 | 0.408 | 0.556 | 4309 |
| 17. | (Y_{0.95}Ce_{0.05})_{3.0}Al₅O_{12.00} | 486 | 568.0 | 547.0 | 115.2 | 0.422 | 0.549 | 4069 |

I_{a.units}—relative brightness; λ_{dom}, nm—the dominant wavelength in the luminescence spectrum; λₚₑₐₖ, nm—the position of the maximum in the luminescence spectrum, Δλ_{0.5} is the width of the luminescence band at half-height of the maximum coordinate; T_{c}, nm—colour temperature, K.

As one can see that the vast majority of luminescent materials with the exception of the samples with the lowest cerium concentration, exceed the prototype in brightness and colour characteristics and that they are no inferior to commercial phosphors.

1. A luminescent material for solid white light sources, based on yttrium aluminate, and also including cerium oxide and represented by the general formula:
(Y₁₋ₓCeₓ)_{3±α}Al₅O_{12±1.5α},
wherein x is an atomic fraction of cerium in a range of 0.01-0.20, wherein α is a deviation of a stoichiometric index for yttrium garnet either towards more than 3, which corresponds to positive values, or towards less than 3, which corresponds to negative values, wherein positive values correspond to oxygen indices varying in the 12+1.5α range, and wherein negative values correspond to oxygen indices varying in the 12-1.5αrange.

2. The luminescent material according to claim 1, wherein the positive values vary within a range of 0<α<0.5, wherein α=0 is excluded from a set of possible values.

3. The luminescent material according to claim 1, wherein the negative values vary within a range of 0<α≦1.5, wherein α=0 is excluded from a set of possible values.
